(19) United States
(12) Patent Application Publication
(10) Pub. No.: US 2010/0030523 A1
(43) Pub. Date: Feb. 4, 2010

(54) PASSENGER CONVEYER ABNORMALITY DIAGNOSIS SYSTEM

(75) Inventors: Yosuke MURAO, Tokyo (JP); Masaki SAKURAI, Tokyo (JP)

Correspondence Address: FOLEY AND LARDNER LLP;SUITE 500, 3000 K STREET NW, WASHINGTON, DC, 20007, US

(73) Assignee: TOSHIBA ELEVATOR KABUSHIKI KAISHA

(21) Appl. No.: 12/508,709

(22) Filed: Jul. 24, 2009

(30) Foreign Application Priority Data
Jul. 29, 2008 (JP) 2008-194949

(51) Int. Cl. G06F 15/00; G01N 29/14

(52) U.S. Cl. 702/183

(57) ABSTRACT

In a passenger conveyer abnormality diagnosis system, sound data of escalator operating sound of a plurality of revolutions is collected by a moving sound collector provided for an inspection step and then processed into a data set for diagnosis with an accidental external noise component removed. The data set for diagnosis sent from a data transceiver through a communication network to a remote monitoring apparatus installed at a remote-located monitoring center. The remote monitoring apparatus diagnose the presence of abnormalities of the escalator based on the data set for diagnosis.

### BACKGROUND OF THE INVENTION

1. Field of the Invention

The present invention relates to an abnormality diagnosis system which diagnoses abnormalities of a passenger conveyer such as an escalator or moving sidewalk.

2. Description of the Related Art

In a passenger conveyer such as an escalator or moving sidewalk, a number of steps connected in an endless manner are circulated along a guide rail provided within a torus to convey passengers on the steps. Once such a passenger conveyer breaks down, it takes a long time to recover the same. The breakdown may cause a lot of inconvenience to the customers. It is therefore desired to promptly find abnormalities just after the abnormalities occur before the passenger conveyer breaks down and to solve the abnormalities with a maintenance operation to avoid breakdown.

In the light of such a background, in Patent Publication 1, a diagnosis apparatus including an acceleration sensor, a microphone, and the like is provided for one of circulating steps. With such a structure, in terms of acceleration signals detected by an acceleration sensor or sound signals detected by a microphone in a predetermined zone, at least any one of average amplitude, kurtosis, and step period component is obtained as a statistical feature quantity. The obtained statistical feature quantity is compared with a predetermined setting feature quantity to determine the presence of abnormalities in the passenger conveyer.

Patent Publication 1: Japanese Patent Laid-open Publication No. 2007-8709.

With a method of determining the presence of abnormalities in the passenger conveyer using the statistical feature quantity as described in Patent Publication 1, in the case where accidental external noise not related to the operation of the passenger conveyer occurs, the inverse effect of the external noise on the diagnosis is prevented if the external noise is small. However, for example, when comparatively large external noise occurs, such as sound of passengers walking or BGM or information broadcasted in the facility where the passenger conveyer is installed, the effect of the external noise appears in the statistical feature quantity. This makes it difficult to accurately diagnose abnormalities in the passenger conveyer in some cases.

### SUMMARY OF THE INVENTION

The present invention was made to solve the aforementioned problem of the conventional art, and an object of the present invention is to provide a passenger conveyer abnormality diagnosis system capable of accurately diagnosing abnormalities of a passenger conveyer even when comparatively large external noise occurs.

According to a first aspect of the present invention, an abnormality diagnosis system of a passenger conveyer includes: a sound collector collecting operating sound of the passenger conveyer; a data calculator which processes sound data of the operating sound of the passenger conveyer collected by the sound collector during a plurality of revolutions of steps to create a data set for diagnosis; and an abnormality judgment apparatus which judges whether there is an abnormality caused in the passenger conveyer using the data set for diagnosis created by the data calculator. The data calculator divides the sound data of the operating sound of the passenger conveyer of each revolution into a plurality of sound data packets by time sections common to each other, compares the sound data packets of each time section of the plurality of revolutions to each other to extract the sound data packet with a lowest maximum value of the sound data, and puts together the extracted sound data packets to create the data set for diagnosis corresponding to one revolution.

With the abnormality diagnosis system of a passenger conveyer according to the first aspect of the present invention, the data set for diagnosis is created by putting together data assumed not to include an external noise component, and using the crated data set for diagnosis, the presence of abnormalities of the passenger conveyer is diagnosed. It is therefore possible to effectively prevent comparatively large external noise from affecting the diagnosis and achieve highly accurate diagnosis of abnormalities of the passenger conveyer.

### BRIEF DESCRIPTION OF THE DRAWINGS

FIG. 1 is a configuration view schematically showing a configuration of an abnormality diagnosis system to which the present invention is applied.

FIG. 2 is a block diagram showing an internal configuration of a moving sound collector installed in an inspection step.

FIG. 3 is an explanatory view illustrating a specific example of a method of processing sound data of escalator operating sound of a plurality of revolutions of steps to create a data set for diagnosis.

FIG. 4 is a view illustrating an example for calculating length of time sections dividing the sound data into intervals of the sound data based on moving speed of the steps and a distance between step rollers of pairs of adjacent steps.

### DESCRIPTION OF THE EMBODIMENT

Hereinafter, a description is given in detail of a specific embodiment of the present invention with reference to the drawings. The following embodiment shows an escalator including a number of steps diagonally moving between upper and lower floors as an example of a passenger conveyer which is a target for diagnosis. However, it is obvious that the present invention can be effectively applied to a diagnosis of a moving sidewalk including a number of steps (footplates) continuously moving in the horizontal direction.

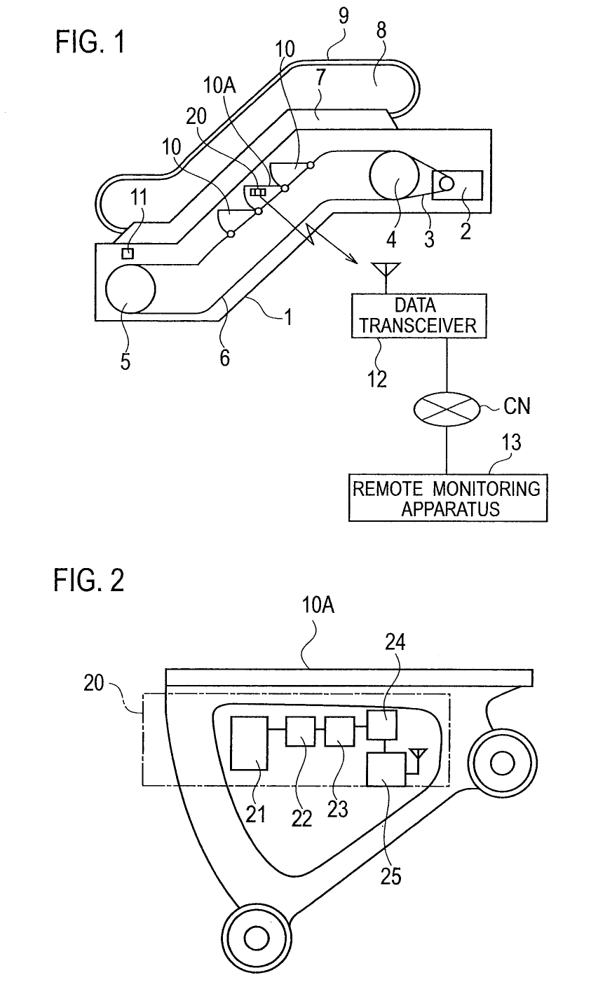

As shown in FIG. 1, the escalator, which is a target for diagnosis, is supported by a torus 1 laid between the upper and lower floors. An escalator drive apparatus 2 is installed on the upper floor side within the torus 1 and drives a driving sprocket 4 through a drive chain 3. A driven sprocket 5 paired with the driving sprocket 4 is installed on the lower floor side within the torus 1. A step chain 6 is wound around the driving and driven sprockets 4 and 5. A number of steps 10 are coupled to the step chain 6. With such a structure, the drive apparatus 2 rotates the driving sprocket 4 to rotate the step chain 6 around the driving and driven sprockets 4 and 5. The number of steps 10 therefore circulate along a not-shown guide rail between the entrance and exit on the upper and lower floors.

Moreover, balustrades each composed of a deck board 7 and a balustrade panel 8 are stood on both sides of the steps 10 circulating. On the periphery of each balustrade panel 8, a handrail belt 9 is attached. The handrail belt 9 is a handrail which held by passengers on the steps 10. The handrail belt 9 rotates around the balustrade panel 8 in synchronization with movement of the steps 10 through, for example, the transmitted drive force of the aforementioned drive apparatus 2.

In the escalator configured as described above, in order to allow a diagnosis by the abnormality diagnosis system of this embodiment, at least one of the number of steps 10 circulating is configured to serve as an inspection step 10A. A moving sound collector 20 is installed within the inspection step 10A. The moving sound collector 20 rotates together with the inspection step 10A and collects escalator operating sound to create a data set for diagnosis. At a predetermined position (a referential position) on a circulation route of the number of steps 10 including the inspection step 10A, a position detector 11 is set. The position detector 11 performs a non-contact close-distance wireless communication with the moving sound collector 20 when the inspection step 10A passes the referential position and outputs a referential position passing signal to the moving sound collector 20.

Moreover, a data transceiver 12 is installed at a site where the escalator as a target for diagnosis is installed. Moreover, a remote monitoring apparatus 13 is installed in a remote-located monitoring center. The remote monitoring apparatus 13 is connected to the data transceiver 12 at the site of the escalator through a communication network CN. The abnormality diagnosis system of this embodiment is composed of the moving sound collector 20, position detector 11, data transceiver 12, and remote monitoring apparatus 13 and is configured as a system capable of automatically diagnosing abnormalities of the escalator in the remote-located monitoring center.

For example as shown in FIG. 2, the moving sound collector 20 includes a sound collection unit 21, a data recording unit 22, a calculation unit (a data calculator) 23, a diagnosis data memory 24, and a wireless communication unit 25. The sound collection unit 21 collects the escalator operating sound. The data recording unit 22 preserves sound data of the escalator operating sound collected by the sound collector 21. The calculation unit 23 processes the sound data of the escalator operating sound preserved in the data recording unit 22 to create a data set for diagnosis. The diagnosis data memory 24 stores the data set for diagnosis created by the calculation unit 23. The wireless communication unit 25 wirelessly sends the data set for diagnosis stored in the diagnosis data memory 24.

The moving sound collector 20 continuously collects the escalator operating sound with the sound collection unit 21 during a plurality of revolutions of the circulating inspection step 10A (for example, about three or four revolutions) at predetermined intervals, such as everyday or ever week. The length of one revolution is determined based on the referential position passing signal sent from the position detector 11. The escalator operating sound of one revolution is escalator operating sound collected by the sound collection unit 21 until the inspection step 10A passes the referential position again after previously passing the same.

The sound data of the escalator operating sound of a plurality of revolutions which is continuously collected by the sound collection unit 21 is stored in the data recording unit 22. The calculation unit 23 then processes the sound data of the escalator operating sound of the plurality of revolutions stored in the data recording unit 22 and creates a data set for diagnosis in which accidental external noise not related to the operation of the escalator is removed. The data set for diagnosis created by the calculation unit 23 is once stored in the diagnosis data memory 24; properly read from the diagnosis data memory 24; and then wirelessly sent to the data transceiver 12 through the wireless communication unit 25.

The data transceiver 12 receives the data set for diagnosis wirelessly sent from the wireless communication unit 25 and sends the received data set for diagnosis to the remote monitoring apparatus 13 installed in the remote-located monitoring center through the communication network CN. The remote monitoring apparatus 13 receives the data set for diagnosis sent from the data transceiver 12 located at the site of the escalator through the communication network CN, judges the presence of abnormalities of the escalator using the data set for diagnosis (an abnormality judgment apparatus), and outputs the judgment results. The judgment of abnormalities of the escalator by the remote monitoring apparatus 13 is performed for example by the following method: the escalator operating sound is previously collected while the escalator is normally operating, and the sound data thereof is stored and is compared with the data set for diagnosis. When there is a difference exceeding a predetermined threshold value therebetween, it is judged that the escalator is abnormal.

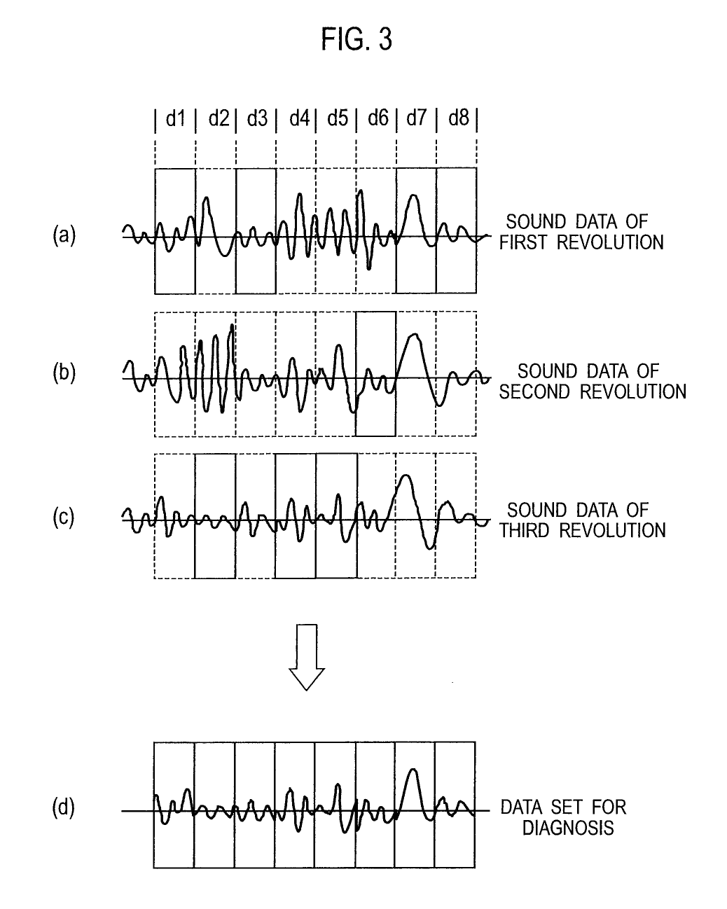

Herein, with reference to FIG. 3, a description is given in detail of a specific example of the method of processing the sound data of the escalator operating sound of a plurality of revolutions to create the data set for diagnosis. FIG. 3 shows an example of creating the data set for diagnosis corresponding to one revolution of the inspection step 10A from the sound data of the escalator operating sound of three revolutions.

The calculation unit 23 first divides sound data of the escalator operating sound which is continuously collected during a plurality of revolutions and is stored in the data recording unit 22 into sound data of each revolution. Moreover, the sound data of the escalator operating sound of each revolution is divided by a plurality of common time sections into a plurality of sound data packets. The example shown in FIG. 3, (a), (b), and (c) shows sound data of the first, second, and third revolutions, respectively. The sound data of each revolution is divided by eight time sections d1 to d8.

Next, the calculation unit 23 compares the sound data packets of each time section in the plurality of revolutions to each other and extracts the sound data packet with the lowest maximum value of the sound data. In other words, the calculation unit 23 compares the sound data packets obtained while the inspection step 10A is moving in the same zone of the route and extracts a sound data packet with the lowest maximum value of the sound data as a diagnosis data packet of the zone concerned. In the example shown in FIG. 3, at the first time section d1, the maximum value of the sound data of the first revolution is smaller than that of the other revolutions. The calculation unit 23 extracts the sound data packet of the first revolution as the diagnosis data packet of the time section d1. At the second time section d2, the maximum value of the sound data of the third revolution is smaller than that of the other revolutions. The calculation unit 23 extracts the sound data packet of the third revolution as the diagnosis data packet of the time section d2. In a similar manner, the calculation unit 23 extracts the sound data packets of the first revolution, third revolution, third revolution, second revolution, first revolution, and first revolution as the diagnosis data packets of the time sections d3 to d8, respectively.

Next, the calculation unit 23 puts together the extracted diagnosis data packets of the plurality of time sections to create data set for diagnosis corresponding to one revolution as shown in (d) of FIG. 3. The data set for diagnosis shown in (d) of FIG. 3 is created by putting together the sound data packet of the first revolution at the time section d1, the sound data packet of the third revolution at the time section d2, the sound data packet of the first revolution at the time section d3, the sound data packet of the third revolution at the time section d4, the sound data packet of the third revolution at the time section d5, the sound data packet of the second revolution at the time section d6, the sound data packet of the first revolution at the time section d7, and the sound data packet of the first revolution at the time section d8.

This data set for diagnosis is created in order to remove accidental external noise not related to the operation of the escalator. Specifically, when the sound collection unit 21 of the moving sound collector 20 receives accidental external noise, the external noise component thereof is superimposed on the escalator operating sound, thus temporarily increasing the level of the sound data. However, since the data set for diagnosis is created by putting together the sound data packets with the smallest maximum values of the sound data in the plurality of revolutions as described above, external noise is removed from the data set for diagnosis.

The maximum value of the sound data of each sound data packet may be evaluated by a peak-to-peak value of the voltage waveform. The sound collection unit 21 generally outputs a waveform of oscillation as a voltage waveform according to the sound pressure of the escalator operating sound. Accordingly, by evaluating the maximum value of the sound data of each sound data packet with the peak-to-peak value of the voltage waveform and extracting the sound data packet with the smallest peak-to peak value of the voltage waveform, the data set for diagnosis can be created directly using the voltage waveform outputted from the sound collection unit 21. This can extremely facilitate the process of creating the data set for diagnosis.

Instead of evaluating the maximum value with the peak-to-peak value of the voltage waveform, for example, the sound data packet with the smallest effective value of voltage may be extracted. Alternatively, the voltage waveform is transformed into a pressure waveform, and the sound data packet with the smallest peak-to-peak value or effective value of the pressure waveform is extracted. Furthermore, the maximum value of the sound data may be evaluated using a result of a frequency analysis thereof. In this case, the sound data packet with the smallest maximum value of the frequency spectrum is extracted.

As the method of dividing the sound data of the escalator operating sound of each revolution by the plurality of time sections, for example, it is effective to evenly divide the sound data of the escalator operating sound into an even number of sound data packets by time sections of length obtained by dividing the time taken for the step 10A to revolve once by an even number. In other words, since the circulation route of the step 10A includes outward and homeward routes, if the sound data is divided into an even number of sound data packets, the sound data can be handled separately in the outward and homeward routes. Moreover, the equal length of the time sections facilitates dividing the sound data. The shorter the time sections serving as the basis of the divisions, the more reliable the data set for diagnosis is but the heavier the processing load is. Accordingly, the length of the time sections is set to a proper value considering the balance thereof. According to the experiments by the inventors, the optimal length of the time sections is not more than 3 seconds and especially about 1.5 to 2 seconds.

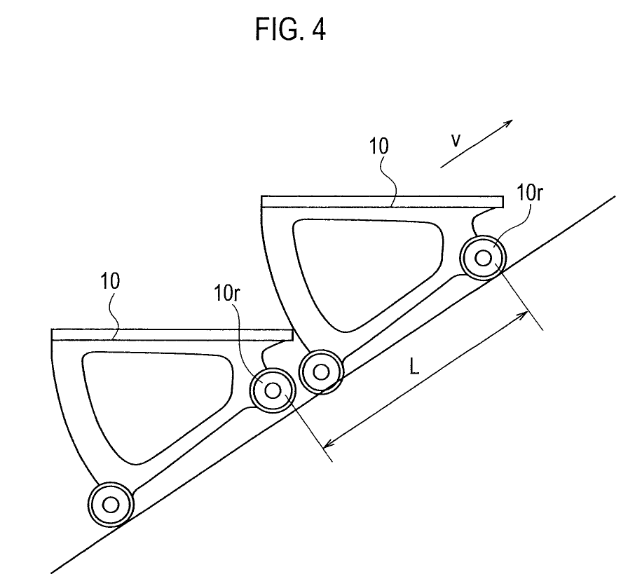

Moreover, as the method of dividing the sound data of the escalator operating sound of each revolution by the plurality of time sections, for example, it is effective that the sound data of the escalator operating sound of each revolution is evenly divided into the plurality of sound data packets by the time sections of length which is obtained by dividing the time taken for one of the steps 10 to revolve once by the total number of the steps 10. The length of the time sections obtained in this case is equal to the time for one of the steps 10 to pass a certain position after the next preceding step 10 passes the same position (unit running time). Accordingly, the sound data can be handled based on the unit running time. Moreover, the equal length of the time sections facilitates dividing the sound data. As shown in FIG. 4, the length of the time sections corresponding to the unit running time can be obtained by dividing a distance L between step rollers 10r of the steps 10 adjacent to each other by a moving speed v of the steps 10. Accordingly, the sound data can be divided very easily even when the moving speed v of the steps 10 is variable.

As described above in detail with the specific examples, according to the abnormality diagnosis system of this embodiment, the data set for diagnosis with an accidental external noise component removed is created by collecting the sound data of the escalator operating sound of a plurality of revolutions of the steps 10 through the moving sound collector 20 installed in the inspection step 10A and processing the collected sound data. The created data set for diagnosis is sent from the data transceiver 12 through the communication network CN to the remote monitoring apparatus 13 installed in the remote-located monitoring center, in which the presence of abnormalities of the escalator is then diagnosed based on the data set for diagnosis. It is therefore possible to automatically diagnose the presence of abnormalities at the remote-located monitoring center based on the escalator operating sound at the site of the escalator. Furthermore, even when comparatively large external noise occurs while the escalator operating sound is being collected, such external noise can be effectively prevented from affecting the diagnosis. It is therefore possible to provide accurate diagnosis of abnormalities of the escalator.

In the aforementioned abnormality diagnosis system, it is assumed that the data set for diagnosis of one revolution of the steps 10 is created at predetermined intervals, such as everyday or every week, and the diagnosis of abnormalities of the escalator is performed based on the created data set for diagnosis. However, the escalator abnormality diagnosis may be performed based on a secondary processing data for diagnosis. The secondary processing data for diagnosis is created by performing the creation of the data set for diagnosis several times a day and, for the plurality of created data sets for diagnosis, conducting processing similar to the creation of the data set for diagnosis from the sound data of the escalator operating sound of a plurality of revolutions.

Specifically, the moving sound collector 20 performs collection of the escalator operating sound by the sound collector unit 21 several times a day. At each time thereof, the moving sound collector 20 executes the aforementioned processing by the calculator unit 23 to create data sets for diagnosis and stores the created data sets for diagnosis in the diagnosis data memory 24. After the plurality of data sets for diagnosis are stored in the diagnosis data memory 24, the calculation unit 23 reads the plurality of data sets for diagnosis and divides each of the plurality of data sets for diagnosis into a plurality of secondary sound data packets by secondary time sections common to the plurality of data sets for diagnosis. The secondary sound data packets of each data set for diagnosis are compared to each other, and the secondary sound data packet with the lowest maximum value of the sound data is extracted. The extracted secondary sound data packets are put together to create the secondary processing data set for diagnosis corresponding to one revolution. The secondary time sections serving as a basis of divisions may be the same as the time sections used at creating the data set for diagnosis or may be different time sections specific to creation of the secondary processing data set for diagnosis. Moreover, the method of evaluating the maximum value of sound data may be the same as that used at creating the data set for diagnosis or another method specific to creation of the secondary processing data set for diagnosis.

In the secondary processing data set for diagnosis created as described above, external noise which remains unremoved by the creation of the data for diagnosis is removed. The secondary processing data set for diagnosis has a high accuracy as data for diagnosis. In a similar way to the aforementioned embodiment, the secondary processing data set for diagnosis is wirelessly sent from the wireless communication unit 25 of the moving sound collector 20 to the data transceiver 12 located at the site of the escalator and then sent from the data transceiver 12 to the remote monitoring apparatus 13 through the communication network CN. In the remote monitoring apparatus 13, the presence of abnormalities of the escalator is judged using the secondary processing data set for diagnosis, and the result thereof is outputted. In this example, it is possible to more reliably prevent the inverse effect of accidental external noise on the diagnosis and diagnose abnormalities of the escalator more accurately.

In the aforementioned abnormality diagnosis system, it is assumed that the remote monitoring apparatus 13 installed in the remote-located monitoring center judges the presence of abnormalities of the escalator based on the difference between the data set for diagnosis or secondary processing data for diagnosis sent from the data transceiver 12 and normal sound data. However, the remote monitoring apparatus 13 may use the plurality of data sets for diagnosis or secondary processing data sets for diagnosis created on different days by the moving sound collector 20 and sent from the data transceiver 12 and observe temporal changes thereof to judge the presence of abnormalities of the escalator based on the results of the observation.

Even when the escalator operating sound includes temporary abnormal noise for any reason, if the noise is reduced on the next day, the noise is not urgent and is enough to inspect at the next maintenance check in many cases. Accordingly, by observing the temporal changes in data for diagnosis based on the plurality of data sets for diagnosis or secondary processing data sets for diagnosis created on different days, abnormal noise which occurs temporarily is determined to be normal, and when abnormal noise occurs continuously, it is judged that the escalator is abnormal. The diagnosis of abnormalities can be therefore performed more accurately.

Moreover, the aforementioned escalator abnormality diagnosis system is just an example of the embodiment of the present invention. Various changes, modifications, and alternative technologies can be applied without departing from the scope of the present invention. For example, in the aforementioned abnormality diagnosis system, one of the number of steps 10 serves as the inspection step 10A, and the escalator operating sound is collected by the moving sound collector 20 installed in the inspection step 10A to create the data set for diagnosis. However, the abnormality diagnosis system may include a plurality of inspection steps at which the moving sound collectors 20 are individually provided, and each of the moving sound collectors 20 collects the escalator operating sound and creates the data set for diagnosis. Moreover, instead of or in addition to the moving sound collector 20 installed in the inspection step 10A, a fixed sound collector is installed at a place where abnormal noise often occurs, such as inside the torus 1, for collection of the escalator operating sound and creation of the data set for diagnosis.

Moreover, in the aforementioned abnormality diagnosis system, the data set for diagnosis is created in the moving sound collector 20. However, the data set for diagnosis can be created in the data transceiver 12 or remote monitoring apparatus 13. In this case, the moving sound collector 20 collects the escalator operating sound and sends the sound data thereof to the data transceiver 12, and the data transceiver 12 processes the sound data with the aforementioned method to create the data set for diagnosis. Alternatively, the data transceiver 12 sends the sound data of the escalator operating sound to the remote monitoring apparatus 13, and the remote monitoring apparatus 13 processes the sound data with the aforementioned method to create the data set for diagnosis.

In the aforementioned abnormal diagnosis system, the escalator abnormality diagnosis using the data set for diagnosis is performed in the remote monitoring apparatus 13. However, the escalator abnormality diagnosis may be performed in the moving sound collector 20. In this case, the results of the diagnosis are sent through the data transceiver 12 to the remote monitoring apparatus 13. Alternatively, the escalator abnormality diagnosis may be performed in the data transceiver 12 using the data set for diagnosis from the moving sound collector 20, and the results of the diagnosis may be sent to the remote monitoring apparatus 13.

What is claimed is:

1. An abnormality diagnosis system of a passenger conveyer which includes a number of circulating steps joined in an endless manner and conveys passengers on the steps, the system comprising:
a sound collector collecting operating sound of the passenger conveyer;
a data calculator which processes sound data of the operating sound of the passenger conveyer collected by the sound collector during a plurality of revolutions of the steps to create a data set for diagnosis; and
an abnormality judgment apparatus which judges whether there is an abnormality caused in the passenger conveyer using the data set for diagnosis created by the data calculator, wherein
the data calculator divides the sound data of the operating sound of the passenger conveyer of each revolution into a plurality of sound data packets by time sections common to each other, compares the sound data packets of each time section of the plurality of revolutions to each other to extract the sound data packet with a lowest maximum value of the sound data, and puts together the extracted sound data packets to create the data set for diagnosis corresponding to one revolution.

2. The abnormality diagnosis system of a passenger conveyer according to claim 1, wherein
the data calculator evaluates the maximum value of the sound data with a peak-to-peak value of a voltage waveform and extracts the sound data packet with the lowest peak-to-peak value of the voltage waveform as the sound data packet for use in the data set for diagnosis.

3. The abnormality diagnosis system of a passenger conveyer according to claim 1, wherein
the data calculator evenly divides the sound data of the operating sound of the passenger conveyer of each revolution by time sections of length which is obtained by dividing time taken for the steps to revolve once by an even number.

4. The abnormality diagnosis system of a passenger conveyer according to claim 1, wherein
the data calculator evenly divides the sound data of the operating sound of the passenger conveyer of each revolution into the plurality of sound data packets by time sections of length which is obtained by dividing time taken for the steps to revolve once by the total number of the steps.

5. The abnormality diagnosis system of a passenger conveyer according to claim 1, wherein
the data calculator performs creation of the data set for diagnosis several times a day, divides each of the created data sets for diagnosis into a plurality of sound data packets by common time sections, compares the sound data packets of each time section to each other, extracts the sound data packet with a smallest maximum value of the sound data, and puts together the extracted sound data packets to create a secondary processing data set for diagnosis corresponding to one revolution, and
the abnormality judgment apparatus judges whether there is an abnormality caused in the passenger conveyer using the secondary processing data set for diagnosis crated by the data calculator.

6. The abnormality diagnosis system of a passenger conveyer according to claim 1, wherein
the abnormality judgment apparatus observes temporal changes in a plurality of the data sets for diagnosis or secondary processing data sets for diagnosis created on different days by the data calculator and judges based on the result of the observation whether there is an abnormality caused in the passenger conveyer.
